(19) United States
(12) Patent Application Publication
(10) Pub. No.: US 2007/0013145 A1
(43) Pub. Date: Jan. 18, 2007

(54) Cylinder head gasket

(75) Inventors: Klaus Detmann, Walluf (DE); Stefan Opitz, Huenstetten (DE); Tobias Gruhler, Pfullingen (DE); Frank Schaible, Esslingen (DE)

Correspondence Address: Edward J. Timmer, P.O. Box 770, Richland, MI, 49083, US

(73) Assignee: ElringKlinger AG

(21) Appl. No.: 11/524,654

(22) Filed: Sep. 21, 2006

Related U.S. Application Data
(62) Division of application No. 11/070,654, filed on Mar. 2, 2005.

(30) Foreign Application Priority Data
Mar. 17, 2004 (DE) 10 2004 012 905.3

(51) Int. Cl. F02F 11/00

(52) U.S. Cl. 277/593

(57) ABSTRACT

Cylinder head gasket with a gasket plate formed by at least one layer of sheet metal and at least one combustion chamber aperture which is enclosed by a sealing device serving the purpose of sealing the combustion chamber, wherein in order to reduce any warpages of an engine block and/or of a cylinder head a supporting device is provided radially outside the sealing device on the gasket plate; so that the supporting device can be produced in a material-saving and procedurally reliable manner, the supporting device has an area of the sheet-metal layer which is thickened by way of embossing and does not enclose any of the apertures of the gasket to be sealed completely or almost completely and has at least one embossed supporting bead with a meandering shape or a two-dimensional pattern of cup-like recesses and associated elevations.

The present disclosure relates to the subject matter disclosed in German application No. 10 2004 012 905.3 of Mar. 17, 2004, which is incorporated herein by reference in its entirety and for all purposes.

### BACKGROUND OF THE INVENTION

The invention relates to cylinder head gaskets, namely essentially metallic cylinder head gaskets which have a gasket plate, the main component of which is a layer of sheet metal or several layers of sheet metal placed on top of one another. In particular, the invention relates to cylinder head gaskets for multi-cylinder engines; insofar as such engines do not have a separate cylinder head gasket for each individual cylinder, the cylinder head gasket has an elongated gasket plate with several combustion chamber apertures which are arranged in a row one behind the other, the centers of which may, however, also be located on a zigzag line extending in the longitudinal direction of the gasket plate.

The locations of a cylinder head gasket which are the most critical with respect to the effect of sealing are the areas surrounding the combustion chamber apertures since it is necessary to seal against the highest pressures (combustion gas pressure) at these points. A cylinder head gasket is, therefore, normally configured such that, measured in a direction at right angles to the gasket plate, the thickness of the gasket plate or of the elements of the gasket plate around the combustion chamber apertures is particularly great (so-called combustion chamber superelevation) in order to achieve particularly high pressing forces around the combustion chamber apertures when a cylinder head gasket is clamped between cylinder head and engine block. Above all on account of the lightweight construction of cylinder head and engine block of modern engines, this combustion chamber superelevation can lead to warpages of the engine components, i.e., in the cylinder head, in certain circumstances, however, also in the engine block and/or in the cylinder liners (insofar as the engine has such liners). These warpages are particularly great in those areas of the engine components, between which the longitudinal end areas of the cylinder head gasket are clamped, an effect which is augmented by the fact that the high combustion gas pressures resulting in the combustion chambers have the tendency to cause the cylinder head to arch (away from the engine block), i.e., be deformed between its longitudinal ends. Only for the sake of completeness, reference is made to the fact that these phenomena also occur, in principle, in the case of engines with one cylinder, with which the cylinder head is connected to the engine block via four cylinder head screws which pass through the cylinder head gasket in the vicinity of its four corners so that the cylinder head screws are arranged in pairs so as to be adjacent to two sides of the engine located opposite one another.

In the case of cylinder head gaskets of the type mentioned at the outset for modern engines, i.e., in the case of metallic cylinder head gaskets, the sealing device provided around a combustion chamber aperture mostly has the form of one or several bead or beads which is or are impressed into one or several layers of sheet metal and has or have spring-elastic properties, wherein the bead can be a so-called full bead (with a cross section in the approximate shape of an arc) or a so-called semi-bead, the cross section of which is approximately step-like. Since such a sealing bead must retain its spring-elastic properties during operation of the engine in order to be able to fulfill its sealing function, it may not be flattened to too great an extent during the tightening of the cylinder head screws, i.e., during the assembly of the cylinder head gasket and during operation of the engine; for this purpose, known cylinder head gaskets of the type in question have, apart from the sealing bead enclosing a combustion chamber aperture, a deformation limiting device which is normally designated as a stopper. In a plan view of the cylinder head gasket, a stopper is located either between the combustion chamber aperture and the sealing bead or on the side of the sealing bead facing away from the combustion chamber aperture and next to it; there are, however, also cylinder head gaskets, with which a stopper is provided on both respective sides of the sealing bead. The stopper likewise encloses the combustion chamber apertures completely or at least almost completely and has a smaller height than the unstressed sealing bead so that the latter may be flattened in a spring-elastic manner when acted upon by the pressure of the cylinder head gasket only to such an extent until the stopper acts as a stop and prevents any further flattening of the sealing bead. Stoppers often have the form of sheet-metal rings welded onto a layer of sheet metal of the cylinder head gasket.

In order to reduce the warpages in the engine components described above and caused by the so-called combustion chamber superelevation, supporting devices have already been provided in the areas of the longitudinal ends of the gasket plate in the case of multi-layered metallic cylinder head gaskets for multi-cylinder engines and as a result of these supporting devices the sum of the material thicknesses of the elements of the gasket (measured at right angles to the plane of the gasket plate) is increased at certain points, i.e., at the locations of the supporting devices. In the case of a three-layered metallic cylinder head gasket with two external sheet-metal layers (cover layers) which are provided with sealing beads enclosing the apertures to be sealed and a carrier sheet-metal layer arranged between the cover layers, sheet-metal tongues connected to the carrier sheet-metal layer have been punched out during the punching out of the latter and then folded back onto the actual carrier sheet-metal layer so that a double thickness of sheet metal results at the locations of the sheet-metal tongues. In one embodiment of this three-layered cylinder head gasket, the supporting devices created as a result are located in the vicinity of the longitudinal ends of the gasket plate. Sheet-metal tongues of this type, which are placed around or folded back onto a sheet-metal layer, are, however, not completely without problems for the production process—if a sheet-metal tongue protrudes beyond the actual periphery of the sheet-metal layer prior to being folded back, this results in a greater material requirement and, in addition, the procedure of folding back such a sheet-metal tongue in a so-called follow-on tool is a process which is not, in every case, procedurally reliable.

Furthermore, in the case of metallic cylinder head gaskets, supporting devices are known, the shape of which corresponds to that of a so-called wave stopper such as that described in the journal MTZ 10/2001, pages 816-824—a wave stopper is part of a sealing device which is provided around an aperture to be sealed and consists of a spring-elastic bead enclosing the aperture to be sealed and a wave stopper which has the form of several full beads which extend parallel to one another, are impressed into a sheet-metal layer, likewise enclose the aperture to be sealed at least more or less and the crests of which have an arc-shaped form in a plan view of the sheet-metal layer. In MTZ 10/2003, pages 842-849, in particular, pages 846-848, supporting devices of this type which are derived from a wave stopper are mentioned and these are arranged in the area of the longitudinal ends of the gasket plate of a cylinder head gasket and are intended to reduce the warpages of the engine components mentioned in the above.

The invention deals with essentially metallic cylinder head gaskets with supporting devices for reducing warpages of components, i.e., the invention relates to a cylinder head gasket with a gasket plate which has at least one layer of sheet metal and at least one combustion chamber aperture which is enclosed by a sealing device serving the purpose of sealing the combustion chamber, wherein to reduce any warpages of an engine block and/or a cylinder head, between which the cylinder head gasket is to be clamped by means of cylinder head screws, the gasket plate has next to or at a distance from the radially outer side of the sealing device with respect to the combustion chamber aperture at least one supporting device for absorbing clamping forces which extend at right angles to the gasket plate and act on the cylinder head gasket when this is installed, the supporting device being generated by a deformation of the at least one sheet-metal layer, namely such a deformation that the material thickness measured at right angles to the gasket plate or the sum of the material thicknesses of the elements of the gasket plate lying one on top of the other is greater in the area of the supporting device than in areas of the gasket plate adjacent to the supporting device.

The object underlying the invention was to design the sealing device serving to reduce the warpages of components in such a cylinder head gasket such that it has, on the one hand, a greater rigidity against deformation in relation to pressing forces extending at right angles to the plane of the gasket plate and may, on the other hand, be produced in a material-saving and procedurally reliable manner.

### SUMMARY OF THE INVENTION

In the case of a cylinder head gasket of the type covered by the invention, this object may be accomplished in accordance with the invention in that the supporting device, as is known per se, has an area of the sheet-metal layer which is thickened by way of embossing, that this thickened supporting area encloses none of the apertures of the gasket which are to be sealed completely or almost completely, and that the thickened supporting area has
(a) at least one embossed supporting bead which (or rather the crest of which) has a meandering shape in a plan view of the sheet-metal layer, or
(b) a pattern of cup-like recesses produced by way of flow-pressing or by way of a deep-drawing process, this pattern being two-dimensional in a plan view of the sheet-metal layer, elevations formed by material of the sheet-metal layer displaced during the impressing of the recesses being associated with said recesses, wherein the overall thickness of the sheet-metal layer is greater in the area of the elevations and recesses than the original thickness of the sheet-metal layer.

Flow pressing means a pressing method, embossing or die-stamping during which metal is displaced by flowing or creeping.

If a supporting device is formed by beads extending parallel to one another and having a course which is, in the plan view, in a straight line or arc-shaped, the cylinder head gasket clamped between engine block and cylinder head cannot offer any really great resistance to the flattening of the beads since displacement movements of areas of the sheet-metal layer in the plane of the layer transverse to the course of the beads, which occur with the flattening of those beads forming the supporting device, cannot be completely prevented. In the case of inventive cylinder head gaskets with supporting beads of a meandering shape, no appreciable displacement movements of this type can, however, occur during any pressure load on the supporting device on account of the meandering shape of the course of the beads, for which reason a supporting bead with a meandering shape can withstand considerably greater pressing forces without being appreciably flattened, and this applies all the more for the case where the supporting device has, in accordance with the invention, a two-dimensional pattern of extruded recesses and elevations.

EP-1 298 364-A as well as EP-1 298 365-A of the company ElringKlinger AG disclose stoppers in the form of areas of a sheet-metal layer of cylinder head gaskets which have been thickened by way of embossing, wherein the stoppers have, in particular, the following configurations: A supporting bead, which is designed in a meandering shape in a plan view of the sheet-metal layer and extends along the sealing bead to be protected by the stopper, is generated by means of a deep-drawing tool in the sheet-metal layer provided with the sealing bead or in a sheet-metal layer adjacent to this sheet-metal layer; in another embodiment, the stopper is generated by flow-pressing, wherein a pattern of cup-shaped recesses which is two-dimensional in the plan view of the sheet-metal layer is generated in an annular area of the sheet-metal layer (which is adjacent to the sealing bead to be protected by the stopper in the plan view of the cylinder head gasket), elevations formed by material of the sheet-metal layer displaced during the impressing of the recesses being associated with these recesses—in this respect, the overall thickness of the sheet-metal layer is greater in the area of the elevations and recesses than the original thickness of the sheet-metal layer, i.e., the thickness of the sheet-metal layer prior to its deformation by way of flow-pressing.

The supporting devices in question differ, however, quite fundamentally from stoppers: Whereas a spring-elastic sealing bead to be protected by a stopper is always associated with this stopper and the stopper is located in the direct vicinity of the sealing bead and extends at least essentially over the entire length of the sealing bead and around an aperture of the gasket to be sealed, a supporting device according to the present invention has none of these features characteristic of a stopper even if a sealing bead can extend in the vicinity of a supporting device—in this case, the supporting device extends only along a section of the sealing bead which is much shorter than the overall length of the sealing bead; further, the effective height of the supporting device may be the same as or even greater than the height of the bead. Therefore, the supporting device shall not take over the function of protecting the sealing bead from any excessive flattening.

In the case of a multi-layered, inventive cylinder head gasket, the supporting device or the supporting devices can be provided in the same sheet-metal layer as the sealing device or the sealing devices or in another layer since it is, primarily, only of importance for the thickness of the compressed cylinder head gasket to be increased at the location of the supporting device. In a plan view of the cylinder head gasket, the distance of the supporting device from the sealing device located closest to it is generally, at least over a greater part of the length of this sealing device, considerably greater than the width of the sealing device (measured in a radial direction with respect to the aperture of the cylinder head gasket which is to be sealed and is associated with the sealing device), namely even when the sealing device consists of one or several sealing beads and one or several stoppers protecting them. When a greater material thickness or a greater overall thickness in the area of a supporting device is mentioned in the above, the material thickness or the thickness of the supporting device is to be understood as the distance between two tangential planes which extend parallel to the plane of the gasket plate and are tangent to the supporting device on both sides and enclose it between them. The apertures of the cylinder head gasket which are to be sealed are to be understood primarily as its combustion chamber apertures; if the cylinder head gasket does, however, have apertures for the passage of, for example, a cooling medium or of oil which are to be sealed with one or several sealing devices of the cylinder head gasket, such as is the case for, e.g., a sealing bead which extends in the vicinity of the periphery of a cylinder head gasket, forms a complete, continuous line and encloses a group of such apertures of the cylinder head gasket which have a fluid flowing through them, the definition that the thickened supporting area of an inventive supporting device does not enclose any of these apertures completely or almost completely also relates to this case. Furthermore, preferred embodiments are characterized by the fact that when the cylinder head gasket has a sealing bead adjacent to an inventive supporting area, the supporting area extends only over a smaller part of the length of the sealing bead adjacent to it, i.e., over less than half the length of this sealing bead.

As is apparent from the preceding explanations, component warpages or deformations occur in the case of multi-cylinder engines, in particular, in the area of the longitudinal ends of the engine. In the case of a cylinder head gasket with an elongated gasket plate which has several combustion chamber apertures between its two longitudinal ends, at least two inventive supporting areas, which are arranged in the vicinity of the longitudinal ends of the gasket plate, will, therefore, be expediently provided. In the case of a cylinder head gasket with an elongated gasket plate which has several combustion chamber apertures between its two longitudinal ends, screw apertures for the passage of cylinder head screws are normally provided in the vicinity of these longitudinal ends; when a cylinder head gasket is installed, increased pressing forces result around the cylinder head screws and this applies, in the case of a cylinder head gasket for a multi-cylinder engine, to an even greater extent for the cylinder head screws adjacent to the longitudinal ends of the gasket since these screws are associated only with the two terminal combustion chambers whereas cylinder head screws arranged between adjacent combustion chambers are associated with two respective combustion chambers, for which reason, in preferred embodiments of inventive cylinder head gaskets for multi-cylinder engines, at least two inventive supporting areas are provided which are located in the vicinity of the screw apertures adjacent to the longitudinal ends of the gasket plate.

Additional features, advantages and details of the invention result from the attached claims and/or from the attached drawings and the following description of the preferred embodiments of the invention illustrated in these drawings; in the drawings:

### BRIEF DESCRIPTION OF THE DRAWINGS

FIG. 1 shows a partial, somewhat schematic plan view of an inventive cylinder head gasket;

FIGS. 2 and 3 show sections according to lines 2-2 and 3-3 from FIG. 1, wherein a first, particularly advantageous embodiment of inventive supporting devices has been illustrated;

FIG. 4 shows the left-hand part of FIG. 2 on an enlarged scale;

FIG. 5 shows a perspective illustration of a section of an inventive supporting device, namely of an embodiment somewhat modified in comparison with the embodiments according to FIGS. 2 to 4;

FIGS. 6 and 7 show two additional embodiments of an inventive supporting device in the case of a two-layered gasket;

FIG. 8 shows a plan view of part of an inventive cylinder head gasket with an inventive supporting device formed by embossed meandering beads;

FIGS. 8A, 8B, 8C and 8D show sections according to line 8-8 in FIG. 8 through four different variations of the cylinder head gasket shown in FIG. 8;

FIG. 9 again shows a plan view of part of an inventive cylinder head gasket with a supporting device formed by embossed meandering beads, and

FIG. 10 shows a section according to line 10-10 in FIG. 9.

### DETAILED DESCRIPTION OF THE INVENTION

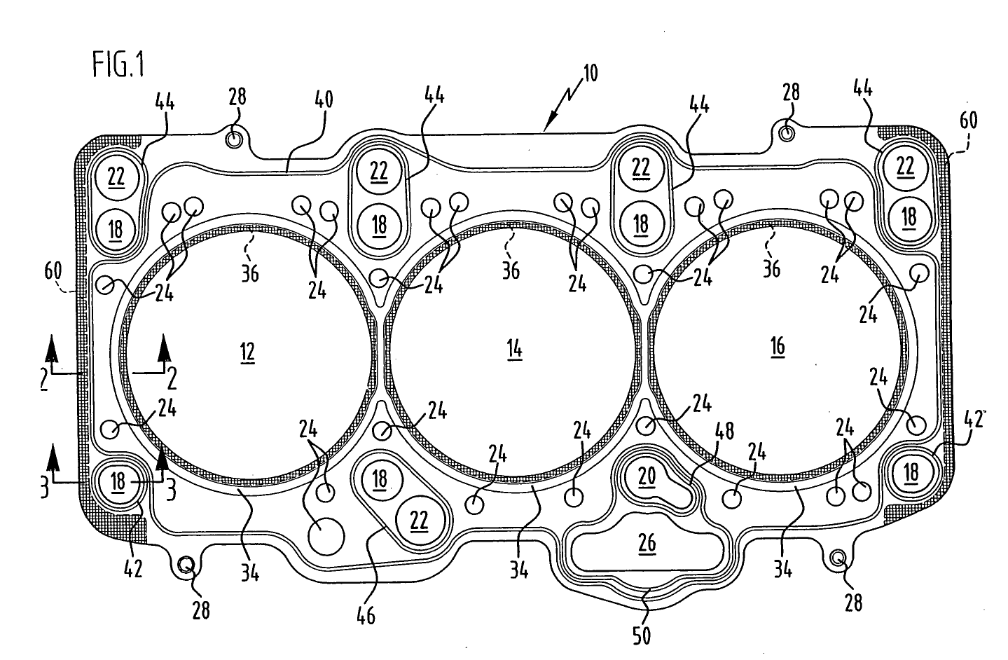

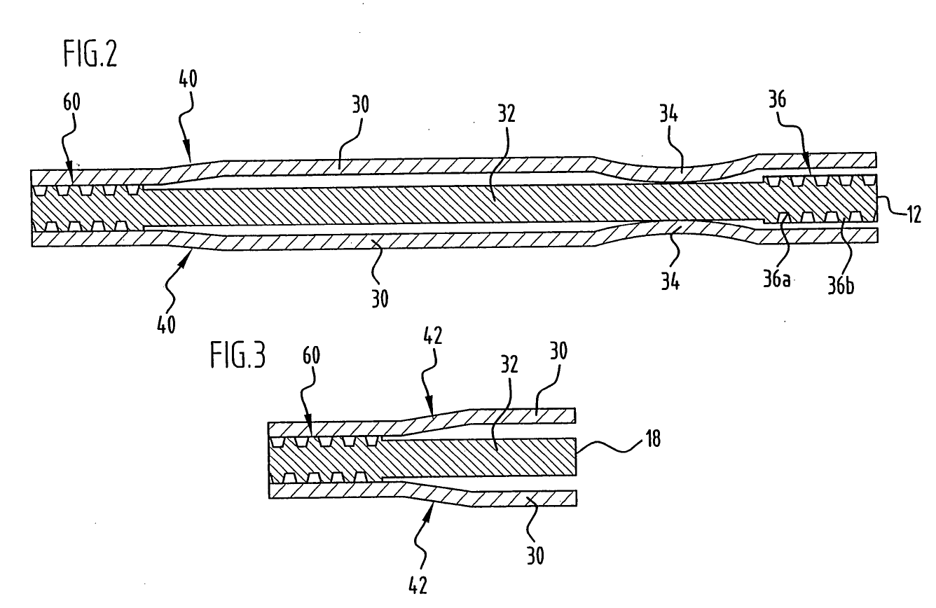

The three-layered (cf. FIGS. 2 to 4) cylinder head gasket illustrated in a plan view in FIG. 1 has a gasket plate 10 with a plurality of apertures, namely three combustion chamber apertures 12, 14 and 16, seven screw holes 18 of a, as usual, circular shape, an aperture 20 for the passage not only of a cylinder head screw but also of lubricating oil, five additional, circular apertures 22 for the passage of lubricating oil, several cooling water apertures 24 of different sizes as well as an oil return aperture 26 for the return flow of lubricating oil from the cylinder head to the engine block. Compression rivets, with which the three sheet-metal layers of the cylinder head gasket are connected to one another, are designated as 28.

As is apparent from FIG. 1 in conjunction with FIGS. 2 to 4, the gasket plate 10 is composed of two cover sheet-metal layers 30 and a carrier sheet-metal layer 32 arranged therebetween. The cover sheet-metal layers consist of a metal sheet of spring steel whereas the carrier sheet-metal layer has been produced from a steel sheet which can be deformed plastically by way of flow-pressing and could, however, have been hardened once the carrier sheet-metal layer 32 has been given its final shape. Each of the cover sheet-metal layers 30 has for each of the combustion chamber apertures 12, 14 and 16 a spring-elastic sealing bead 34 which projects in the direction towards the carrier sheet-metal layer 32 and is designed as a so-called full bead, wherein the two sealing beads associated with a combustion chamber aperture are located opposite one another. So that the sealing beads 34 cannot be flattened to an inadmissibly great extent during the clamping of the cylinder head gasket and during operation of the engine, the carrier sheet 32 is provided around each combustion chamber aperture and, in particular, immediately adjacent to this with a stopper 36 which forms a thickened area of the carrier sheet-metal layer 32, wherein this area extends around the relevant combustion chamber aperture in the form of an annular band. In the embodiment illustrated, the stopper 36 projects beyond both main surfaces of the carrier sheet-metal layer 32 and is formed by a two-dimensional pattern consisting of flow-pressed, cup-like recesses 36a and elevations 36b, wherein these elevations are formed by material of the sheet-metal layer which has been displaced during the impressing of the recesses and an elevation 36b is located directly opposite each recess 36a on the other side of the carrier sheet-metal layer 32. Such a two-dimensional pattern, which will be described in detail later on, is illustrated in FIG. 5 which, however, does not, on the one hand, illustrate a stopper but rather an inventive supporting device and, on the other hand, a configuration which is modified to the extent that in FIG. 5 a recess is located opposite each recess and an elevation opposite each elevation. As in FIG. 5, the stopper 36 from FIG. 2 is intended, however, to also have a chessboard-like pattern of recesses and elevations on both sides of the carrier sheet-metal layer 32. As is clear from FIG. 2, the sealing beads 34 can, therefore, be flattened only to such an extent until the respective cover sheet-metal layer 30 rests on the stopper 36.

All the water holes 24 are enclosed by a sealing bead 40 which forms a complete, continuous line in the vicinity of the periphery of the gasket plate 10 and has the form of a semi-bead, as results from FIG. 2. The water holes 24 are, therefore, located between the sealing bead 40 and the sealing beads 34, with respect to which it should be noted for the sake of completeness that the sealing bead 34 surrounding the one combustion chamber aperture merges into the sealing bead 34 surrounding the other combustion chamber aperture in the narrow web areas between two adjacent combustion chamber openings 12, 14 and 14, 16, respectively, so that only a single sealing bead 34 is located in such a web area in each of the cover sheet-metal layers 30.

A sealing bead 42 likewise designed as a semi-bead extends around the screw holes 18 located in the two lower corners of the gasket plate 10 according to FIG. 1 in each of the two cover sheet-metal layers 30, as is shown in FIGS. 1 and 3. Additional sealing beads 44, 46, 48 and 50 designed as semi-beads in each of the cover sheet-metal layers 30 surround a respective pair of apertures formed by a screw hole 18 and an aperture 22 for lubricating oil or the aperture 20 for a cylinder head screw and lubricating oil or the oil return aperture 26 as well as the sealing bead 48.

As is apparent in FIG. 1, the cylinder head gasket has, at the longitudinal ends of the gasket plate 10, a respective inventive supporting device 60 which, as is apparent from FIGS. 2 to 4, is a thickened area of the carrier sheet-metal layer 32 which has been generated as a result of embossing of the carrier sheet-metal layer and has, in the plan view of the latter, the shape of an elongated, band-like area of the carrier sheet-metal layer which does not represent either a complete formation nor does it enclose any aperture of the cylinder head gasket or extend along a bead of the cylinder head gasket such that the supporting device extends over the entire or the predominant length of this bead adjacent to the latter, as would be the case for a stopper.

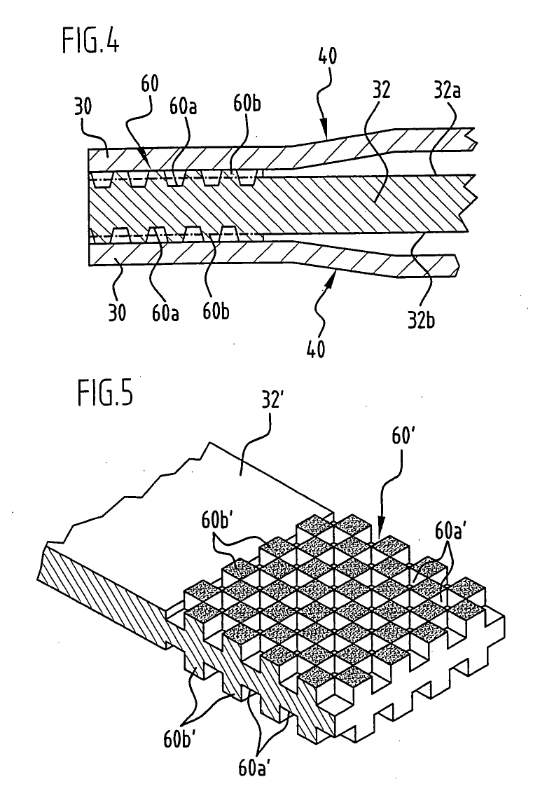

As is apparent, in particular, from FIG. 4, such a supporting device 60 has impressed recesses 60a and elevations 60b resulting due to displacement of material which are intended to form a chessboard-like pattern of elevations and recesses on each of the two sides of the carrier sheet-metal layer 32, as illustrated for a modified embodiment in FIG. 5. It follows from the fact that the recesses 60a and the elevations 60b have resulted in or on the carrier sheet-metal layer 32 in accordance with the invention as a result of embossing, namely by way of flow-pressing, that the sum of the volumes of those parts of the recesses 60a which are located between the planes defined by the two main surfaces 32a and 32b of the carrier sheet-metal layer 32 (illustrated in FIG. 4 by dash-dot lines) is equal to the sum of the volumes of those parts of the elevations 60b which rise above the said planes. Furthermore, in a preferred embodiment the elevations 60b project on the one side of the carrier sheet-metal layer the same distance beyond the one of these two planes as the elevations 60b on the other side of the carrier sheet-metal layer beyond the other one of these two planes, above all when the two sealing beads 40 which are adjacent to the supporting device 60 and located on the two sides of the gasket plate 10 are of the same height.

In the embodiment of a supporting device illustrated in FIGS. 2 to 4, namely in the case of the supporting device 60,.an elevation 60b is located directly opposite each recess 60a. In this respect, the embodiment of an inventive supporting device 60′ illustrated in FIG. 5 differs from the embodiment according to FIGS. 2 to 4 insofar as in the embodiment according to FIG. 5 a recess 60a′ is likewise located directly opposite respective recesses 60a′ impressed into a carrier sheet-metal layer 32′ and an elevation 60b′ is likewise located directly opposite each elevation 60b′, wherein this is the only difference in comparison with the embodiment according to FIGS. 2 to 4.

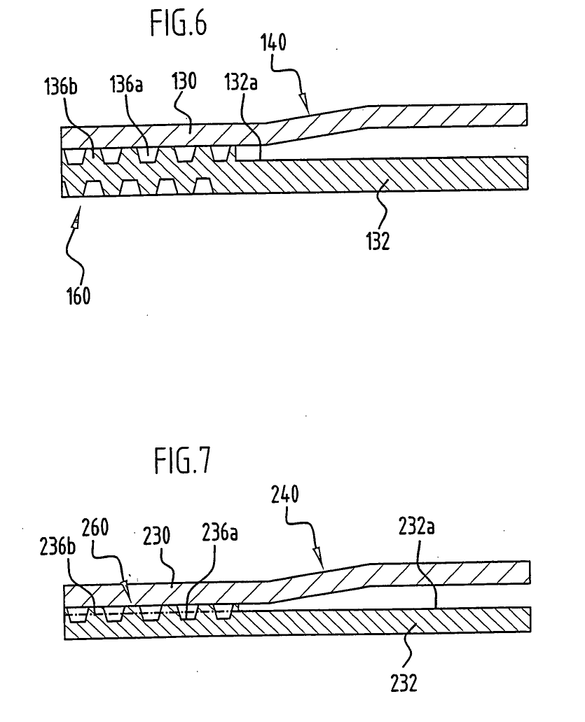

FIGS. 6 and 7 show sectional illustrations corresponding to FIGS. 3 and 4 through two additional embodiments of inventive supporting devices but in two-layered cylinder head gaskets. The same reference numbers have been used in FIGS. 6 and 7 as in FIGS. 3 and 4 but increased by 100 or 200 so that it is sufficient when, in the following, only the differences between the embodiments illustrated in FIGS. 6 and 7 and the embodiment according to FIGS. 2 to 4 are described.

Since the cylinder head gasket partially illustrated in FIG. 6 is only two-layered and has a cover sheet-metal layer 130 as well as a carrier sheet-metal layer 132, it is sufficient when the supporting device 160 provided on the carrier sheet-metal layer 132 projects only beyond the main surface 132a of the carrier sheet-metal layer 132 facing the cover sheet-metal layer 130, namely with elevations 136b which have a respective recess 136a which is impressed into the carrier sheet-metal layer 132 located directly opposite them. In plan views of the carrier sheet-metal layer 132, the recesses 136a and the elevations 136b, respectively, are intended to again form a chessboard-like pattern similar to the pattern illustrated in FIG. 5. Furthermore, the sum of the volumes of the recesses 136a is intended to be equal to the sum of the volumes of the elevations 136b, as results from extrusion with a tool which has stamp-like projections for the impressing of the recesses 136a and cup-like recesses in a support surface for the carrier sheet-metal layer 132 for the accommodation and shaping of the elevations 136b.

Whereas in the embodiment illustrated in FIG. 6 the recesses 136a are located on one side of the carrier sheet-metal layer 132 and the elevations 136b on the other side, the recesses 236a and the elevations 236b of the embodiment illustrated in FIG. 7 are located on the same side of a carrier sheet-metal layer 232 so that during the impressing of the recesses 236a the material of the carrier sheet-metal layer 232 displaced thereby is displaced to the side and the embossing tool for producing the supporting device 260 has, on the one side, a flat, complete supporting surface for the carrier sheet-metal layer 232 and, on the other side, a tool surface which is provided with stamp-like projections for the impressing of the recesses 236a as well as with cup-like recesses for accommodating and shaping the elevations 236b. In the embodiment according to FIG. 7, the sum of the volumes of the elevations 236b, insofar as these project beyond the plane defined by the main surface 232a of the carrier sheet-metal layer 232 and illustrated in FIG. 7 by a dash-dot line, is equal to the sum of the volumes of the recesses 236a, insofar as these are located beneath this plane.

Since, in the case of the type of inventive supporting device explained in the above, these devices are generated by way of flow-pressing, this type of supporting device is particularly resistant to pressure since, as a result of the deformation of the sheet-metal layer occurring during embossing, the material is markedly hardened. An additional advantage of this type of supporting device is to be seen in the fact that these supporting devices form a relatively large contact and supporting surface with the domes of the elevations which form a two-dimensional pattern and are located at least essentially in a common plane and so during any subjection to force the specific surface pressure relating to the surface unit of this supporting surface is relatively small. Consequently, the elevations of this type of supporting device do not lead to indentations in the sealing surfaces of cylinder head and/or engine block, namely not even when these elevations—different to the embodiments illustrated—abut directly against such a sealing surface of an engine component and are not covered by an additional sheet-metal layer of the cylinder head gasket. In this connection, it must be borne in mind that sheet-metal layers of cylinder head gaskets provided with spring-elastic sealing beads have a relatively slight material thickness, i.e., are relatively thin which can, in the case of supporting devices formed by straight-lined or arc-shaped beads, lead to the fact that the effect of the high specific surface pressures occurring at the crests of straight-lined or arc-shaped beads penetrates through such a thin and spring-elastic sheet-metal layer and these pressures result in corresponding indentations in the sealing surface of a cylinder head and/or in the sealing surface of an engine block.

The impressed cup-like recesses of a supporting area may be produced by embossing (similar to deep-drawing) instead of flow-pressing, so that each of the recesses impressed into one side of the sheet-metal layer is located directly opposite a knob-like elevation on the other side of the sheet-metal layer.

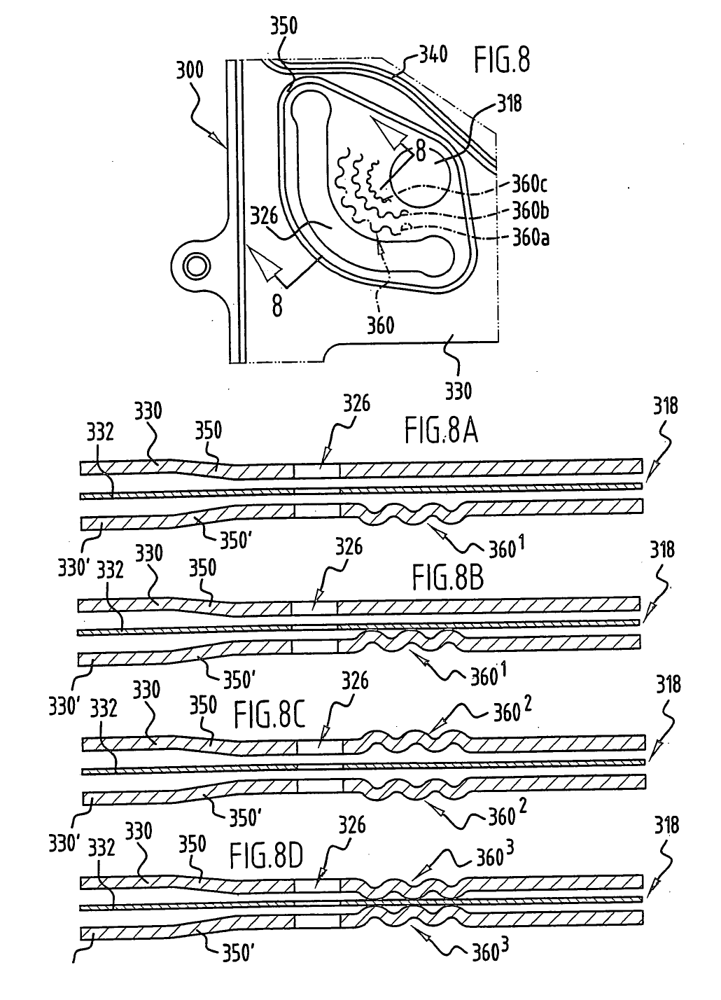

FIGS. 8 to 10 show sections of inventive cylinder head gaskets with a second type of inventive supporting device having embossed supporting beads which have a meandering shape in a plan view of the cylinder head gasket.

FIG. 8 shows a plan view of a corner area of a gasket plate 300 of an inventive cylinder head gasket, wherein this corner area can correspond to the left-hand, lower corner area of the gasket illustrated in FIG. 1. In the case of the cylinder head gasket illustrated in FIG. 8, this is, again, intended to be a three-layered gasket, the cover sheet-metal layer 330 of which, which is the top layer in FIG. 8, is provided with a sealing bead 340 corresponding to the sealing bead 40 illustrated in FIG. 1 and a sealing bead 350 corresponding to the sealing bead 50 illustrated in FIG. 1. Furthermore, the area of the gasket plate 300 shown in FIG. 8 has a screw hole 318 and an oil return aperture 326, the two of which are enclosed together by the sealing bead 350.

An inventive supporting device 360 is provided adjacent to the screw hole 318, various embodiments of this supporting device being illustrated in detail in FIGS. 8A to 8D. It is common to all these embodiments that one or several supporting beads is or are impressed into one or several sheet-metal layers of the gasket for forming an inventive supporting device, wherein each of these supporting beads has a meandering shape or rather a meandering course in a plan view of the relevant layer of sheet metal and in the case of several such supporting beads these preferably extend at least essentially parallel to one another. Three such supporting devices are indicated in FIG. 8 by dash-dot lines and designated as 360a, 360b as well as 360c.

In FIG. 8A, the cover sheet-metal layer 330 and an additional cover sheet-metal layer 330′ accommodate a third sheet-metal layer 332 between them and the cover sheet-metal layer 330′ has a sealing bead 350′ corresponding to the sealing bead 350, wherein these are, in both cases, so-called semi-beads. An inventive supporting device 360¹ is impressed into one of the two cover sheet-metal layers—into the cover sheet-metal layer 330′ in the case illustrated in the drawings—and consists of three meandering supporting beads 360a, 360b and 360c, as illustrated in FIG. 8, which extend parallel to one another and project beyond the cover sheet-metal layer 330′ only on one side, namely beyond the main surface of the cover sheet-metal layer which is the bottom surface in FIG. 8A.

Since the embodiment illustrated in FIG. 8B differs from that according to FIG. 8A only in that the supporting beads do not protrude beyond the outer side of the cylinder head gasket but rather project inwards from the one cover sheet-metal layer, the same reference numerals as in FIG. 8A have been used in FIG. 8B and so no further description of FIG. 8B is required.

This also applies for the embodiments illustrated in FIGS. 8C and 8D because the embodiment according to FIG. 8C differs from the embodiment according to FIG. 8A and the embodiment according to FIG. 8D differs from the embodiment according to FIG. 8B only in that both cover sheet-metal layers 330, 330′ are provided with a supporting device 360² and 360³, respectively.

The embodiments according to FIGS. 8A and 8B are particularly suitable for engines with a light alloy cylinder head which is susceptible to indentations in its sealing surface because a cylinder head gasket according to FIG. 8A or 8B can then be installed such that the supporting device 360¹ is located on the side of the engine block and is covered in the direction towards the cylinder head by several sheet-metal layers.

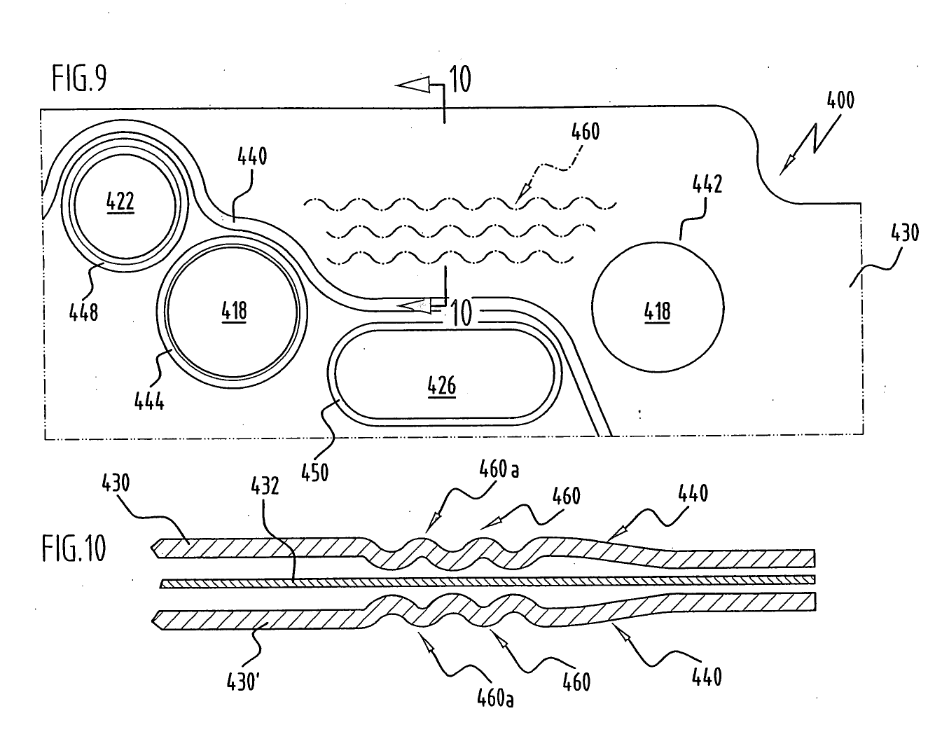

A small area of a gasket plate 400 of a multi-layered cylinder head gasket is, again, illustrated in FIG. 9, namely an area which borders on the periphery of the gasket plate and in which the gasket plate 400 is provided with two screw holes 418, an oil through aperture 422 and an oil return aperture 426. Similar to the embodiment illustrated in FIG. 1, a sealing bead 440 impressed into an upper cover sheet-metal layer 430 extends around numerous apertures of the gasket plate 400, inter alia around the apertures 422, 426 and the one screw hole 418. All the apertures shown in FIG. 9 are also each enclosed by an additional sealing bead 442 and 444 and 448 and 450, respectively, which has likewise been impressed into the cover sheet-metal layer 430.

As is apparent from FIG. 10, the gasket plate 400 comprises, apart from the cover sheet-metal layer 430 which is the top layer in FIG. 9, an additional cover sheet-metal layer 430′ as well as an inner sheet-metal layer 432 and insofar as the area of the cylinder head gasket illustrated in FIG. 9 is concerned, the gasket plate 400 is intended to be designed in mirror symmetry in relation to the sheet-metal layer 432.

In an area of the gasket plate 400 which is located outside the sealing bead 440 according to FIG. 9 and approximately between the two screw holes 418 shown in FIG. 9, the two cover sheet-metal layers 430 and 430′ are provided with an inventive supporting device 460, each of which has three supporting beads 460a which are impressed into the relevant cover sheet-metal layer, have a meandering course in a plan view of the gasket plate or rather the relevant cover sheet-metal layer and extend approximately parallel to one another. As shown in FIG. 10, these supporting beads protrude beyond the relevant cover sheet-metal layer 430 and 430′, respectively, only in a direction towards the sheet-metal layer 432 and the supporting beads are arranged such that the domes of the supporting beads of the one cover sheet-metal layer are located directly opposite the domes of the supporting beads of the other sheet-metal layer, as is also the case for the embodiments according to FIGS. 8C and 8D.

In comparison with supporting beads, the crests of which form a straight line or a circular arc in a plan view of the corresponding sheet-metal layer, supporting devices formed by meandering supporting beads have a considerably greater strength or rigidity with respect to any pressure applied at right angles to the relevant sheet-metal layer, wherein this rigidity or strength of a meandering supporting bead is all the greater, the closer to one another the loops of the meander are located (in a plan view of the relevant sheet-metal layer), i.e., the greater the number of loops the supporting device has in the meander per unit of length (the rigidity does, of course, also increase with the number of supporting beads of a supporting device).

It should be mentioned only for the sake of completeness that in the case of inventive cylinder head gaskets the outer sides of the gasket plates but also main surfaces of layers of sheet metal located in the interior of the gasket plates can be provided with a coating, i.e., with a coating consisting of an elastomeric material in order to improve the sealing properties of the gasket and/or the resistance to corrosion of the gasket. Coatings of this type applied, for example, in spraying or dipping processes can also extend over the elements of inventive supporting devices.

In the case of an inventive cylinder head gasket with several supporting devices, one of these supporting devices may be formed by one or several supporting beads with a meandering shape and another supporting device by an pattern of recesses and associated elevations, i.e., mixed forms are likewise intended to be regarded as falling within the scope of the invention.

According to the invention, instead of an embossed supporting bead, a group of several short impressed or embossed beads may be provided, said short beads preferably extending parallel to one another. In case of an elongated gasket plate said short beads extend in particular obliquely to the longitudinal direction of the gasket plate; alternatively, the beads of a group of said short beads may also be arranged in a substantially circular pattern of beads extending radially with respect to an imaginary center. Such short beads have a length being smaller than the distance between a lateral (smaller) edge of said elongated gasket plate and a screw aperture (for the passage of a cylinder head screw) located adjacent to said lateral edge, and in particular smaller than the diameter of said screw aperture, and still more preferred substantially equal to or smaller than half said diameter.

Preferably, the height or thickness of an inventive supporting device, the area of the gasket plate occupied by said supporting device, and the stiffness of the supporting device shall be chosen such that, after the cylinder head gasket has been installed, the supporting device supports approximately 50% of the tightening pressure applied to the gasket by a cylinder head screw passing through a screw aperture located next to said supporting device.

1. Cylinder head gasket with a gasket plate having at least one layer of sheet metal and at least one combustion chamber aperture enclosed by a sealing device serving the purpose of sealing the combustion chamber, wherein to reduce any deformations of an engine block and/or of a cylinder head when the cylinder head gasket is clamped between said engine block and said cylinder head by means of cylinder head screws, the gasket plate has next to or at a distance from the radially outer side of the sealing device with respect to the combustion chamber aperture at least one supporting device for supporting clamping forces extending at right angles to the gasket plate and acting on the cylinder head gasket when this is installed, said supporting device being generated by such a deformation of the at least one sheet-metal layer that the thickness of the gasket plate measured at right angles to the gasket plate is greater in the area of the supporting device than in areas of the gasket plate adjacent to the supporting device, wherein the supporting device has an area of the sheet-metal layer thickened by way of embossing, wherein this thickened supporting area encloses none of the apertures of the gasket to be sealed completely or almost completely, and wherein the thickened supporting area has
at least one embossed supporting bead having a meandering shape in a plan view of the sheet-metal layer.

2. (canceled)

3. Cylinder head gasket as defined in claim 1, wherein the at least one sheet-metal layer has a sealing bead adjacent to the supporting area, and wherein the supporting area extends only over a smaller part of the length of the sealing bead adjacent to it.

4. Cylinder head gasket as defined in claim 1 with an elongated gasket plate having several combustion chamber apertures between its two longitudinal ends, wherein at least two supporting areas are arranged in the vicinity of the longitudinal ends of the gasket plate.

5. (canceled)

6. Cylinder head gasket as defined in claim 1, wherein the supporting area has at least two supporting beads extending next to one another.

7. Cylinder head gasket as defined in claim 6, wherein the sheet-metal layer has a wave-like shape in a section through the supporting area at right angles to the gasket plate and transversely to the beads.

8-13. (canceled)
